(19) United States
(12) Patent Application Publication
(10) Pub. No.: US 2020/0375183 A1
(43) Pub. Date: Dec. 3, 2020

(54) LIQUID SUSPENSION CONCENTRATE FORMULATION COMPRISING MEFENTRIFLUCONAZOLE

(71) Applicant: SUMITOMO CHEMICAL COMPANY, LIMITED, Tokyo (JP)

(72) Inventor: Hiroto TADA, Takarazuka-shi (JP)

(73) Assignee: SUMITOMO CHEMICAL COMPANY, LIMITED, Tokyo (JP)

(21) Appl. No.: 16/926,434

(22) Filed: Jul. 10, 2020

Related U.S. Application Data
(63) Continuation of application No. 16/507,720, filed on Jul. 10, 2019, now abandoned.

(30) Foreign Application Priority Data
May 31, 2019 (JP) 2019-102246

(51) Int. Cl. A01N 43/653; A01N 25/04

(52) U.S. Cl. CPC A01N 43/653; A01N 25/04

(57) ABSTRACT

An object of the present invention is to provide an aqueous suspension concentrate comprising mefentrifluconazole, which is excellent in pourability from a container, hardly precipitates during storage, and is inhibited from being separated. An aqueous suspension comprising mefentrifluconazole, a surfactant, and water and having a loss tangent tan δ of 0.5 to 0.7.

### CROSS-REFERENCE TO RELATED APPLICATION

This application is a Divisional application of co-pending application Ser. No. 16/507,720, filed on Jul. 10, 2019, which claims the benefit under 35 U.S.C. § 119(a) to Patent Application No. 2019-102246, filed in Japan on May 31, 2019, all of which are hereby expressly incorporated by reference into the present application.

### BACKGROUND OF THE INVENTION

### Field of the Invention

The present invention relates to a liquid suspension concentrate formulation comprising mefentrifluconazole.

### Description of the Related Art

Conventionally, as one of forms of pesticide formulations, aqueous suspension concentrates referred to as SCs, in which particles of a solid pesticidally active ingredient are suspended in water, are known. SCs have problems such as that, if the particles precipitate during storage, they have to be re-suspended when a user uses them. Thus, it is desirable that SCs hardly precipitate. However, when the viscosity of SC is increased to make it hard to precipitate, SC is hardly poured from the container, which may cause problems such as a decrease in work efficiency of the user.

Mefentrifluconazole is known as an active ingredient of a plant disease control agent (see, for example, US Patent Application Publication No. 2014/0155262 A and WO 2017/102905).

### CITATION LIST

### Patent Documents

Patent Document 1: US-2014-0155262-A1

Patent Document 2: WO 2017/102905-A1

### SUMMARY OF THE INVENTION

An object of the present invention is to provide an aqueous suspension concentrate comprising mefentrifluconazole, which is excellent in pourability from a container, hardly precipitates during storage, and is inhibited from being separated.

The present inventor has intensively studied so as to find an aqueous suspension concentrate comprising mefentrifluconazole, which is excellent in pourability from a container, hardly precipitates during storage, and is inhibited from being separated, and found that, by adjusting a value of the loss tangent tan δ of an aqueous suspension comprising mefentrifluconazole, a surfactant, and water to be within a specific range, the separation of the suspension can be inhibited without decreasing the pourability of the suspension from the container.

More specifically, the present invention is as described below.
[1] An aqueous suspension comprising mefentrifluconazole, a surfactant, and water, wherein the aqueous suspension has a loss tangent tan δ of 0.5 to 0.7.
[2] The aqueous suspension according to [1], which comprises a thickener.

According to the present invention, it is possible to provide an aqueous suspension concentrate comprising mefentrifluconazole, which is excellent in pourability from the container, hardly precipitates during storage, and is inhibited from being separated.

### DETAILED DESCRIPTION OF THE PREFERRED EMBODIMENTS

An aqueous suspension according to the present invention (hereinafter referred to as the suspension of the present invention) comprises mefentrifluconazole.

Mefentrifluconazole is a known compound and described, for example, in US Patent Application Publication No. 2014/0155262 A and WO 2017/102905. Mefentrifluconazole can be synthesized by the method as described in US Patent Application Publication No. 2014/0155262 A and WO 2017/102905.

The suspension of the present invention comprises mefentrifluconazole in an amount of usually 1 to 60% by weight, preferably 3 to 50% by weight.

The suspension of the present invention comprises at least one surfactant. Examples of the surfactant include anionic surfactants, nonionic surfactants, cationic surfactants, amphoteric surfactants, and mixtures thereof. Preferred surfactants are anionic surfactants and/or nonionic surfactants. Preferred anionic surfactants are sulfonates, sulfates, phosphates, carboxylates, and mixtures thereof. Examples of sulfonates include naphthalene sulfonate and formaldehyde condensate thereof, alkyl benzene sulfonate, alkyl naphthalene sulfonate, alkyl diphenyl ether disulfonate, α-olefin sulfonate, lignin sulfonate, polyoxyethylene alkyl phenyl ether sulfonate, and dialkyl sulfosuccinate. Examples of sulfates include alkyl sulfate, polyoxyethylene alkyl ether sulfate, and polyoxyethylene alkyl phenyl ether sulfate. Examples of phosphates include polyoxyethylene alkyl aryl ether phosphate and polyoxyethylene tristyryl phenyl ether phosphate. Examples of carboxylates include fatty acid salt and polycarboxylic acid salt. Examples of nonionic surfactants include polyoxyethylene alkyl ether, polyoxypropylene alkyl ether, polyoxyethylene polyoxypropylene alkyl ether, polyoxyethylene distyryl phenyl ether, polyoxyethylene tristyryl phenyl ether, sucrose fatty acid ester, sorbitan fatty acid ester, polyoxyethylene sorbitan fatty acid ester, glycerol fatty acid ester, polyoxyethylene fatty acid ester, polyoxyethylene alkylamine, alkyl alkanolamide, polyoxyethylene polyoxypropylene block copolymer, alkyl polyglycoside, and acrylic co-polymer. Examples of cationic surfactants include alkylamine salt and quaternary ammonium salt. Examples of amphoteric surfactants include alkyl betaine.

The suspension of the present invention comprises a surfactant in an amount of usually 0.5 to 30% by weight, preferably 1 to 20% by weight or 1 to 15% by weight.

The suspension of the present invention comprises water. Examples of water include ion-exchanged water, tap water, and underground water.

The suspension of the present invention comprises water in an amount of usually 30 to 98% by weight, preferably 40 to 90% by weight.

The suspension of the present invention may optionally comprise any other auxiliary agents for formulation. Examples of other auxiliary agents for formulation include thickeners, preservatives, antifreeze agents, and antifoam agents. Suitable thickeners are polysaccharides such as xanthan gum, clays, and silicates. When the suspension of the present invention comprises a thickener, the content of the thickener in total amount of the suspension of the present invention is usually 0.05 to 5% by weight, preferably 0.07 to 3% by weight. Suitable preservatives are isothiazolinone preservatives. When the suspension of the present invention comprises a preservative, the content of the preservative in total amount of the suspension of the present invention is usually 0.05 to 0.5% by weight, preferably 0.1 to 0.3% by weight. Suitable antifreeze agents are ethylene glycol, propylene glycol, urea, and glycerol. When the suspension of the present invention comprises an antifreeze agent, the content of the antifreeze agent in total amount of the suspension of the present invention is usually 1 to 10% by weight, preferably 2 to 8% by weight. Suitable antifoam agents are silicone-based antifoam agents. When the suspension of the present invention comprises an antifoam agent, the content of the antifoam agent in total amount of the suspension of the present invention is usually 0.01 to 1% by weight, preferably 0.05 to 0.5% by weight. The suspension of the present invention comprises mefentrifluconazole, a surfactant, and water in a total amount of 50% by weight or more, 60% by weight or more, or 70% by weight or more. In addition, the suspension of the present invention comprises mefentrifluconazole, a surfactant, water, and a thickener in a total amount of 55% by weight or more, 65% by weight or more, or 75% by weight or more.

The suspension of the present invention may further comprise one or more other pesticidally active ingredients. The other pesticidally active ingredient is preferably a solid pesticidally active ingredient.

The loss tangent tan δ of the suspension of the present invention is 0.5 or more, preferably 0.52 or more. The loss tangent tan δ of the suspension of the present invention is 0.7 or less, preferably 0.65 or less. The loss tangent tan δ of the aqueous suspension is calculated according to the following formula (1):

tan δ=G″/G′ (1)

wherein G′ represents a storage elastic modulus, and G″ represents a loss elastic modulus.

The storage elastic modulus and the loss elastic modulus, as used herein, refer to values measured with a stress controlled rotary rheometer (hereinafter referred to as a rheometer). The loss tangent tan δ of the aqueous suspension is a value calculated based on the above equation (1) from the storage elastic modulus and the loss elastic modulus measured with the rheometer using a cone plate with a diameter of 60 mm under the following conditions: a strain of 2%, an angular frequency of 10 rad/s, and a temperature of 20° C.

The suspension of the present invention can be prepared by methods known per se for the preparation of SCs, for example by mixing mefentrifluconazole, a surfactant, and water, and, optionally further other auxiliary agents for formulation.

The method for producing the suspension of the present invention will be exemplified below.
A1) One or more pesticidally active ingredients, one or more surfactants, and water, and, if necessary, auxiliary agents for formulation are mixed to obtain a suspension. As the pesticidally active ingredients, mefentrifluconazole and, if necessary, other pesticidally active ingredients can be used.
A2) The obtained suspension is fed to a grinder such as a bead mill to grind the pesticidally active ingredient in the suspension, thereby obtaining a suspension (hereinafter referred to as a ground suspension).
A3) One or more thickeners, one or more antifreeze agents and the like are added to the obtained ground suspension as necessary, and mixed to obtain a suspension of the present invention.

The grinding time (in the case of a continuous grinder, the feed rate of the suspension to the grinder), the type of the grinder used and its operating conditions (for example, bead size in the case of a bead mill), and the temperature of the suspension during grinding, in the step of obtaining the ground suspension in the above step A2), are appropriately adjusted to adjust the loss tangent tan δ of the suspension of the present invention within the range of 0.5 to 0.7. When using a batch-type bead mill, the loss tangent tan δ decreases as the bead size decreases, as the grinding time increases, and as the temperature of the suspension during grinding decreases.

Plant diseases can be controlled by applying the suspension of the present invention to plants or their habitat.

A user applies the suspension of the present invention usually from a knapsack sprayer, a spray tank, a spray plane, or an irrigation system. Usually, the suspension of the present invention is diluted with water to the desired application concentration and the spray liquor is obtained. Usually, 20 to 2000 L, preferably 50 to 400 L, of the spray liquor are applied per hectare.

The application rate of the suspension of the present invention may be varied depending on a type of plant, a type or a frequency of an occurrence of plant diseases to be controlled, an application period, an application method, an application site, a climate condition and the like. The application rate of the suspension of the present invention is usually 10 to 100 g per hectare as an amount of mefentrifluconazole.

### EXAMPLES

Hereinafter, the present invention will be described in more detail by way of examples and test examples.

First, the components used for the preparation of an aqueous suspension are indicated below.
Rhodasurf 860/P (polyoxyethylene alkyl ether, manufactured by Solvay)
Atlox 4913 (30 to 35% by weight of an acrylic copolymer, and 65 to 70% by weight, in total, of propylene glycol and water, manufactured by Croda)
Soprophor FLK (40% by weight of polyoxyethylene tristyryl phenyl ether phosphate and 60% by weight of propylene glycol, manufactured by Solvay)
XIAMETER ACP-1500 (silicone-based antifoam agent, manufactured by Toray Dow Corning)
KELZAN S (xanthan gum, manufactured by CP Kelco),
VEEGUM R (magnesium aluminum silicate, manufactured by R. T. Vanderbilt Co., Inc.)
Propylene glycol (manufactured by Adeka)

### Example 1

Ten (10) parts by weight of mefentrifluconazole, 3.6 parts by weight of Rhodasurf 860/P, 0.2 parts by weight of XIAMETER ACP-1500, and 72.9 parts by weight of ion-exchanged water were mixed to obtain a mixture. The mixture and glass beads having a diameter of 1 mm and twice the weight of the mixture were placed in a container. Then, the container was set into a planetary centrifugal mixer (Awatori rentaro, manufactured by THINKY CORPORATION) and the mixture was stirred under conditions: a rotation number of 2000 rpm and room temperature (about 25° C.) for 24 minutes for wet grinding, thereby obtaining 86.7 parts by weight of a ground suspension. 0.2 parts by weight of KELZAN S, 0.4 parts by weight of VEEGUM R, 5 parts by weight of propylene glycol, and 7.7 parts by weight of ion-exchanged water were mixed to obtain 13.3 parts by weight of a thickener-containing liquid.

86.7 parts by weight of the ground suspension and 13.3 parts by weight of the thickener-containing liquid were mixed to obtain an aqueous suspension of the present invention (hereinafter referred to as Present Suspension 1).

### Example 2

20 parts by weight of mefentrifluconazole, 4 parts by weight of Atlox 4913, 0.2 parts by weight of XIAMETER ACP-1500, and 62.5 parts by weight of ion-exchanged water were mixed to obtain a mixture. The mixture and glass beads having a diameter of 1 mm and twice the weight of the mixture were placed in a beaker. The mixture was stirred using a stirrer (Three-One Motor, manufactured by SHINTO Scientific Co., Ltd.) for 40 minutes while heating to 60° C. in a water bath at a rotation number of 1500 rpm for wet grinding, thereby obtaining 86.7 parts by weight of a ground suspension. 0.2 parts by weight of KELZAN S, 0.4 parts by weight of VEEGUM R, 5 parts by weight of propylene glycol, and 7.7 parts by weight of ion-exchanged water were mixed to obtain 13.3 parts by weight of a thickener-containing liquid.

86.7 parts by weight of the ground suspension and 13.3 parts by weight of the thickener-containing liquid were mixed to obtain an aqueous suspension of the present invention (hereinafter referred to as Present Suspension 2).

### Example 3

20 parts by weight of mefentrifluconazole, 4 parts by weight of Atlox 4913, 0.2 parts by weight of XIAMETER ACP-1500, and 62.5 parts by weight of ion-exchanged water were mixed to obtain a mixture. The mixture and glass beads having a diameter of 1 mm and twice the weight of the mixture were placed in a container. Then, the container was set into a planetary centrifugal mixer (Awatori rentaro, manufactured by THINKY CORPORATION) and the mixture was stirred under conditions: a rotation number of 2000 rpm and room temperature (about 25° C.) for 6 minutes for wet grinding, thereby obtaining 86.7 parts by weight of a ground suspension. 0.2 parts by weight of KELZAN S, 0.4 parts by weight of VEEGUM R, 5 parts by weight of propylene glycol, and 7.7 parts by weight of ion-exchanged water were mixed to obtain 13.3 parts by weight of a thickener-containing liquid.

86.7 parts by weight of the ground suspension and 13.3 parts by weight of the thickener-containing liquid were mixed to obtain an aqueous suspension of the present invention (hereinafter referred to as Present Suspension 3).

### Comparative Example 1

Ten (10) parts by weight of mefentrifluconazole, 6 parts by weight of Soprophor FLK, 0.2 parts by weight of XIAMETER ACP-1500, and 70.5 parts by weight of ion-exchanged water were mixed to obtain a mixture. The mixture and glass beads having a diameter of 1 mm and twice the weight of the mixture were placed in a container. Then, the container was set into a planetary centrifugal mixer (Awatori rentaro, manufactured by THINKY CORPORATION) and the mixture was stirred under conditions: a rotation number of 2000 rpm and room temperature (about 25° C.) for 1.7 minutes for wet grinding, thereby obtaining 86.7 parts by weight of a ground suspension. 0.16 parts by weight of KELZAN S, 0.32 parts by weight of VEEGUM R, 5 parts by weight of propylene glycol, and 7.82 parts by weight of ion-exchanged water were mixed to obtain 13.3 parts by weight of a thickener-containing liquid.

86.7 parts by weight of the ground suspension and 13.3 parts by weight of the thickener-containing liquid were mixed to obtain an aqueous suspension (hereinafter referred to as Comparative Suspension 1).

### Comparative Example 2

Three (3) parts by weight of mefentrifluconazole, 3 parts by weight of Soprophor FLK, 0.2 parts by weight of XIAMETER ACP-1500, and 80.5 parts by weight of ion-exchanged water were mixed to obtain a mixture. The mixture and glass beads having a diameter of 1 mm and twice the weight of the mixture were placed in a container. Then, the container was set into a planetary centrifugal mixer (Awatori rentaro, manufactured by THINKY CORPORATION) and the mixture was stirred under conditions: a rotation number of 2000 rpm and room temperature (about 25° C.) for 24 minutes for wet grinding, thereby obtaining 86.7 parts by weight of a ground suspension. 0.2 parts by weight of KELZAN S, 0.2 parts by weight of VEEGUM R, 5 parts by weight of propylene glycol, and 7.9 parts by weight of ion-exchanged water were mixed to obtain 13.3 parts by weight of a thickener-containing liquid.

86.7 parts by weight of the ground suspension and 13.3 parts by weight of the thickener-containing liquid were mixed to obtain an aqueous suspension (hereinafter referred to as Comparative Suspension 2).

### Comparative Example 3

20 parts by weight of mefentrifluconazole, 4 parts by weight of Atlox 4913, 0.2 parts by weight of XIAMETER ACP-1500, and 62.5 parts by weight of ion-exchanged water were mixed to obtain a mixture. The mixture and glass beads having a diameter of 1 mm and twice the weight of the mixture were placed in a container. Then, the container was set into a planetary centrifugal mixer (Awatori rentaro, manufactured by THINKY CORPORATION) and the mixture was stirred under conditions: a rotation number of 2000 rpm and room temperature (about 25° C.) for 27 minutes for wet grinding, thereby obtaining 86.7 parts by weight of a ground suspension. 0.2 parts by weight of KELZAN S, 0.4 parts by weight of VEEGUM R, 5 parts by weight of propylene glycol, and 7.7 parts by weight of ion-exchanged water were mixed to obtain 13.3 parts by weight of a thickener-containing liquid.

86.7 parts by weight of the ground suspension and 13.3 parts by weight of the thickener-containing liquid were mixed to obtain an aqueous suspension (hereinafter referred to as Comparative Suspension 3).

### Measurement of Loss Tangent Tan δ of Aqueous Suspension

For each of Present Suspensions 1 to 3 and Comparative Suspensions 1 to 3, the loss tangent tan δ was calculated by measuring the storage elastic modulus and the loss elastic modulus with a rheometer AR-G2 (TA Instruments) using a cone plate having a diameter of 60 mm under the following conditions: a strain of 2%, an angular frequency of 10 rad/s, and a temperature of 20° C. The results are indicated in Table 1.

### Test Example 1

For each of Present Suspensions 1 to 3 and Comparative Suspensions 1 to 3, 10 g of the aqueous suspension was placed in a 10-mL glass vial and stored for 2 weeks at 54° C., and, thereafter, the degree of separation was measured. The degree of separation was calculated according to the following formula (I):

Degree of separation (%)=y/x×100 (I)
wherein x represents the height (mm) of the whole aqueous suspension in the vial, and y represents the height (mm) of a supernatant formed by separation.

The results are indicated in Table 1.

### Test Example 2

For each of Present Suspensions 1 to 3 and Comparative Suspensions 1 to 3, 10 g of the aqueous suspension was placed in a 10-mL glass vial and stored for 2 weeks at 54° C., and, thereafter, the pourability was measured. The aqueous suspension was discharged from the glass vial by removing the lid of the glass vial and keeping a state in which the mouth was directed down for 3 minutes. The pourability was calculated according to the following formula (II):

Pourability (%)=b/a×100 (II)
wherein a represents a weight of the aqueous suspension (gram) in the vial before discharge, and b represents a weight of the aqueous suspension (gram) in the vial after discharge.

The results are indicated in Table 1.

TABLE 1

| | Present | Present | Present | Comparative | Comparative | Comparative |
|---|---|---|---|---|---|---|
| | Suspension | Suspension | Suspension | Suspension | Suspension | Suspension |
| | 1 | 2 | 3 | 1 | 2 | 3 |
| tanδ | 0.65 | 0.63 | 0.52 | 0.74 | 0.73 | 0.48 |
| Degree of | 9 | 6 | 6 | 72 | 86 | 3 |
| separation (%) | | | | | | |
| Pourability (%) | 2.8 | 3.0 | 3.1 | 1.6 | 1.7 | 3.7 |

What is claimed is:

1. An aqueous suspension comprising mefentrifluconazole, a surfactant, a thickener, and water, wherein an amount of mefentrifluconazole is less than 20% by weight of the aqueous suspension.

2. A method for controlling plant diseases comprising a step of applying the aqueous suspension according to claim 1 to plants or their habitat.
